(19) United States
(12) Patent Application Publication
(10) Pub. No.: US 2016/0340623 A1
(43) Pub. Date: Nov. 24, 2016

(54) SANITARY SELF-ADHESIVE PRODUCTS

(71) Applicant: EURVEST SA, Nivelles (BE)

(72) Inventors: Agnieszka SIKORSKA, Trawniki (PL); Alain LUCIANI, Auriol (FR); Jean KLIMIS, Bruxelles (BE); Estelle BERTIGNON, Mons (BE)

(73) Assignee: EURVEST SA, Nivelles (BE)

(21) Appl. No.: 15/116,455

(22) PCT Filed: Feb. 11, 2014
(86) PCT No.: PCT/EP2014/052670

§ 371 Date: Aug. 3, 2016

(51) Int. Cl. C11D 17/00; C11D 3/22; C11D 3/50

(52) U.S. Cl. CPC C11D 17/0056; C11D 17/00; C11D 3/50; C11D 17/0039; C11D 3/222

(57) ABSTRACT

The instant invention is concerned with a self-adhesive product for sanitary comprising a self-adhesive detergent unit composition shaped with a fingers grip portion, said portion being optionally covered on its external surface by a water-soluble material.

### FIELD OF THE INVENTION

The present invention relates to sanitary composition for cleaning and/or disinfecting and/or deodorizing sanitary elements, especially toilets. It particularly relates to the application of self-adhesive products onto the sanitary elements, preferably detergent compositions.

### TECHNICAL BACKGROUND

Several solutions exist for cleaning and/or disinfecting and/or deodorizing sanitary elements, especially toilets, A first solution consisted in a block placed in cage.

Self-adhesive detergent compositions which can be applied directly to the wall of a sanitary element are also known in the art. They correspond to solid, semi-solid or gel substances which are applied over the wall of a sanitary element, for example the faience of the toilet. These compositions have cleaning and/or disinfecting and/or deodorizing properties and are continuously washed off their supporting wall with the flushes.

Nevertheless, it is desirable to prevent the contact of the detergent composition with the hands of the user which may cause discomfort and/or chemical contaminations. Different applicator devices have thus been developed to prevent any direct contact while the product is handled, positioned and adhered to the sanitary element.

For example, WO-A-2007/008531 discloses a device which includes a tubular body and a plunger. The flowable detergent material, contained inside the body of the device, is dispensed through an orifice in controlled unitized doses to a surface when the plunger is moved toward the body by the user. However, this type of applicator is complex to manufacture and may be unhygienic since the same device is applied several times to the wall of sanitary elements over extended period of times to apply the doses. The device is systematically removed after application of the adhesive compositions.

In WO-A-2011/135330, the self-adhesive composition is contained in a cavity and applied to the wall of the sanitary element with a piston which is moveably engageable within the cavity. The applicator is removed after application of the adhesive composition. This solution also involves similar constraints since the device has a complex shape while it requires high amounts of material, such as plastic, to manufacture the grip. In addition, the device is intended to be reused for several applications.

EP-A-2141221 discloses a self-adhesive preformed detergent product which is provided inside a containment portion made from flexible or rigid material. Such portion is used to stick a preformed detergent product directly onto the surface of the sanitary apparatus while preventing any direct contact of the user with the detergent composition. However; the containment portion still needs to be removed after application. As shown in FIGS. 7a-d of the document, the method of application of a self-adhesive detergent product shows that the device is manipulated with both hands of the users, to grip and remove the containment portion which may be constraining.

In WO 2008/100393, the detergent and adhesive composition is provided between two solid substrates which both need to be removed before use of the composition. The first substrate is removed to apply the adhesive composition directly onto the wall of the toilet. There is also still the need to manipulate the product into the toilet basin after application to remove the second substrate before use.

Additional sanitary products were disclosed to facilitate the process of application of adhesive detergent composition. Particularly, some compositions are provided in a soluble plastic film which itself dissolves locally when applied on a wet sanitary wall to let the detergent adhere to the wall. Such products are disclosed for example in WO 2012/017276. However, the handling of these products still has drawbacks since the user has to hold both sides of the products when he applies it on the wall. This manipulation still triggers a risk that the user touches the wall of the sanitary element.

In a similar manner, the document EP-A-2196531 discloses a unit detergent coating composition for dishwasher wherein the detergent composition is coated with a water soluble material, e.g. polyvinyl alcohol. However, the user is again still required to hold both faces of the product with his finger when applying it on the wall of the sanitary product. The document fails to disclose that the self-adhesive detergent unit has a grip that allows the user to hold only one side of the product.

However there remains a strong felt need for adhesive products which are easy to manufacture and use and remain safe to the user.

### FIGURES

FIGS. 1 to 3 illustrate different shapes of unit composition made according to the instant invention.

### SUMMARY OF THE INVENTION

The applicant has surprisingly discovered that the drawbacks of the prior art could be overcome with the instant invention. It has been found that the claimed products are easy to manufacture, safe to any user and substantially improves the application of the product in sanitary facilities. The products according to the invention can be safely manipulated by the user without any risk of chemical contamination or risk of touching the sanitary wall itself. It resists a sufficient force to stick the composition onto the sanitary element with a single hand. The user does not have to remove either the applicator after the self-adhesive composition is applied onto the sanitary element which considerably simplifies the use of the product.

A first aspect of the invention is concerned with a self-adhesive product for sanitary comprising a self-adhesive detergent unit composition shaped with a fingers grip portion, said portion being optionally covered on its external surface by a water-soluble material.

According to another embodiment, the finger grip portion of the self-adhesive product is covered with a water-soluble material.

According to another embodiment, the water soluble material is a film or a coating.

According to another embodiment the film or coating has a thickness of 5 to 500 μm, more preferably from 10 to 100 μm and even more preferably from 20 to 50 μm.

According to another embodiment the selected water soluble material is selected among soluble polymers, biodegradable plastics, saccharide based components, polyamide resin mixtures or soluble gelling agents or mixtures thereof.

According to another embodiment the soluble polymer is selected among isomalt, maltitol, polyacrylamide, polyacrylic polymer, polyvinyl pyrrolidone (PVP), polyisocyanates, polydiallyldimethylammonium chloride (polyDADMAC), polyethylene glycol (PEG); polyvinyl alcohol (PVA), partially hydrolyzed polyvinyl acetate or mixtures thereof; the saccharide based component is a monosaccharide, a dissacharide, glucose, sucrose, fructose or mixtures thereof; the gelling agent is selected among agar gel, alginate, gums or gelatin or mixtures thereof.

According to another embodiment the fingers grip portion of the self-adhesive detergent unit composition is materialized by at least one protruding portion.

According to another embodiment the protruding portion has a thickness within the range of about 0.6 to about 16 mm, preferably about 2 to about 10 mm, and most preferably of about 8 mm.

According to another embodiment the fingers grip portion of the detergent unit composition is materialized by one or several finger receiving cavities within the volume of the composition said cavities being located on one the same side of the detergent composition.

According to another embodiment the detergent unit composition comprises two or three finger receiving cavities.

According to another embodiment the depth of the finger receiving cavities are within the range of about 0.6 to about 16 mm, preferably about 2 to about 10 mm, and most preferably of about 8 mm.

According to another embodiment the product further comprises an adhesive layer positioned on at least a portion of the external surface of the active body covered with the water-soluble film.

According to another embodiment the product further comprises an additional adhesive element which is dispersed in a material of the active body.

According to another embodiment the self-adhesive composition comprises an additive such as disinfectants, insecticides, enzymes, colored particles, preservatives, biocides, anti-lime scale, dyes, colorant and/or antibacterial agents therein in an amount of from 0 to 20 wt % of the total weight of the applicator, preferably from 1 to 5 wt %.

According to another embodiment the self-adhesive composition comprises perfume, in an amount of from 1 to 25 wt % of the total weight applicator, preferably from 1 to 20 wt %.

Another aspect of the invention is directed to a process for the manufacture of a soluble applicator according to the invention comprising (a) the mixing of the-mixing the ingredients into a solvent or mixture of solvents, (b) removing at least part of the solvent to harden the form thus obtained (c) shaping the paste thus obtained into the desired shape (d) covering the grip portion.

Another aspect of the present invention is directed to the use of a product according to the invention into a sanitary element, preferably a toilet basin.

According to another embodiment the product is applied by a user holding the grip to a dry, moist or wet wall and pressed until the product has adhered.

According to another embodiment the self-adhesive products according to the instant invention are used for cleaning, disinfecting and/or deodorizing a sanitary element, preferably a toilet basin.

### DESCRIPTION OF EMBODIMENTS OF THE INVENTION

The present invention is disclosed in more details in the description that follows.

The products according to the instant invention are non-removable products. This means that they are disposable after use. They involve a self-adhesive detergent unit composition which term intends to cover a body having a pasty consistency, or having a consistency which is such as to be slightly modified in shape by manual pressure, but such as to maintain over time the given shape, even following the action of weak external forces, such as a water flush or discharge.

The size and thickness of the self-adhesive detergent unit composition is such that it bears the significant mechanical stress resulting from the pressure applied by the user when fixing the self-adhesive product onto the wall of the sanitary element. Typically, this stress corresponds to about 25N. Thus, the thickness of the applicator is comprised within the range of about 4 to 20 mm, preferably about 10 to 15 mm. The shape of the composition can result in a profile which has a non-uniform thickness.

The detergent unit composition according to the invention is self-adhesive. Typically, such compositions are disclosed in the documents U.S. Pat. No. 6,667,286 or WO2008/100393 which content is incorporated herein by reference. These detergent compositions usually comprise at least one or several of the following adhesion promoters: polyethylene glycol, cellulose, polysaccharides, starches, whereby the cellulose is selected from the group consisting of sodium carboxymethyl cellulose, hydroxyethyl cellulose, and hydroxypropyl cellulose and the polysaccharides is selected from the group consisting of xanthum gum, agar, gelatin gum, acacia gum, carob bean flour, guar gum, and combination thereof; alginates, diurethanes, gelatins, peetines, oleyl amines, alkyl dimethyl amine oxides, alkyl ethyl sulfates, alkyl etoxylate, stearates, alkali metal stearates and combinations thereof.

Other suitable self-adhesive compositions are those disclosed in the European patent application EP12167737 which is incorporated therein by reference. Other composition such as those disclosed in the European patent application EP13167356.

It can also include additives, i.e. processing or formulation additives. Within the meaning of the present application, additives mean for example disinfectants, insecticides, enzymes, particles such as colored PET or PP, preservatives, biocides, anti-lime scale but also dyes or colorant and/or antibacterial agents. The total amount of additives is generally within the range of 0% to 20%, preferably from about 1% to 20%, more preferably from about 1% to 5% of the total weight of the applicator.

Advantageously, acceptable compositions are those which comprise a saccharide component selected from mono, disaccharide, sugar alcohols or mixtures thereof, as an adhesion promoter in an amount expressed in dry content of from 40 to 65% by weight and a surfactant in an amount expressed in dry content of from 25 to 60% by weight; and residual water in an amount from 1 to 5% by weight, based on the total weight of the composition.

The composition can further comprise perfume. Appropriate perfumes are for example disclosed at paragraph [0064] of US 2008/0255017 which is incorporated herein by reference. The fragrance can be based on flowers fragrance, fruits, spices, and the like. The perfume can be of natural origin or can be synthetized. It is present generally in an amount from 0.1% to 25%, preferably from 1% to 20% by weight of the total detergent unit composition.

In the invention, all percentages are by weight, based on the total weight of the applicator, unless specified otherwise.

Once applied, the detergent composition is progressively dissolved and disappears with the water running onto it. For its use in toilet basins, the product advantageously disappears after 200 flushes. This number of flushes is rapidly attained in domestic use and particularly in large families.

The detergent unit composition according to the invention can be manipulated by the user using one hand. More specifically, the user should be able to hold and apply the composition by holding only one side of the detergent unit composition to avoid any contact with the sanitary wall.

This can be achieved by providing the detergent unit composition with useful shapes, i.e. by providing the detergent unit composition with a grip portion on the face of the composition which is opposed to the surface to be adhered to the sanitary wall. This way, the detergent unit composition, once covered with the water soluble material can be directly seized and manipulated by the user without touching the sanitary wall. Advantageously, the grip portion is covered to prevent the user from touching the chemical composition of the self-adhesive detergent unit composition.

According to a first embodiment, the detergent unit composition has a shape which comprises a fingers grip portion. This portion can be made out of the same material than the rest of the self-adhesive detergent unit composition or made of a specific composition which is fixed to the rest of the detergent composition. Preferably, the detergent composition is made of the same composition and directly shaped with the fingers grip portion. Appropriate shapes can be easily obtained via molding or injecting the material. Other processes which are known and available to the skilled person.

The fingers grip portion corresponds to an element which as such, can be seized by the user with the fingers of a single hand, e.g. two or three fingers to handle the entire product and parts which are related to such portion. The term generally implies that the portion has a limited size in comparison to the rest of the geometry of the sanitary product, i.e. within the same order of magnitude than the size of a phalanx or width of a finger. The grip portion must be located on the surface which is opposite to the surface to be adhered to the sanitary wall.

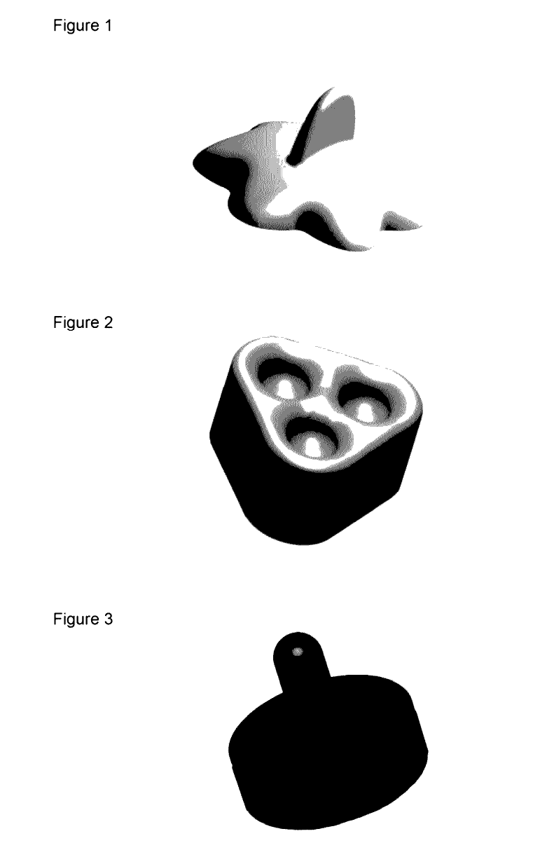

Appropriate grip portions can be materialized under different forms, e.g. such as those disclosed in the European patent application EP13156652, Additional examples of appropriate grip shapes are illustrated in FIGS. 1 to 3 albeit other different shapes can be envisaged by the skilled man.

According to a preferred embodiment, the grip portion corresponds to a protruding portion which can be seized and handled by the fingers of the user. An appropriate thickness for the protruding portion may fall for example within the range of about 0.5 to about 50 mm, preferably about 2 to about 30 mm, and most preferably of about 5 to 15 mm.

According to another embodiment of the invention, the self-adhesive detergent unit composition can be handled by the user with finger receiving cavities that are carved out in the volume of the detergent composition. This embodiment is advantageous in comparison to the grip portion being in the form of a protruding element, as it can prevent the splash-back during use. Two are sufficient to allow the user to seize the product. Three cavities provide further seizure capabilities and ensure that the product does not accidently gets away from the fingers of the user.

Typically, the cavities are all located on the surface which is opposed to the surface to be adhered to the sanitary wall to make sure the user does not have to hold both sides of the product with his fingers which triggers a risk that he gets in contact with the wall of the sanitary element. Alternatively, the cavities can be located at the side of the applicator perpendicular to the sanitary wall.

Typically, the finger receiving cavities exhibit a depth within the range of about 0.6 to about 16 mm, preferably about 2 to 10 mm, and most preferably of about 8 mm. The depth of each cavity does not have to be the same and can be different.

The products made according to the instant invention are intuitive and easy to manipulate and use. They can be applied with one hand only without any risk for the user to touch with the fingers the surface of the sanitary wall.

The entire surface of the detergent unit composition does not have to be covered, but the grip portion which serves for the handling of the sanitary product may be covered with this material to avoid a direct contact with the chemical composition.

The grip portion can be covered by a non-soluble or a water-soluble, material. Advantageously, the material is at least biodegradable, which includes materials that they can break down as a result of a chemical, physical biological or thermic phenomenon within a limited time frame. Biodegradable materials typically encompass compostable materials. Characterization of a biodegradable material can be established according to the European standard NF EN 13432 or EN 14995. Most preferably, the material is water soluble.

Water soluble materials can be selected from any soluble component that would be available to the skilled person. Appropriate soluble coating compositions are disclosed in the European patent application EP-A-2196531 which is incorporated herein by reference.

This includes, polyvinyl alcohol or quaternized polyvinyl alcohol; vinyl alcohol-maleic acid copolymer; ethoxylated polyvinyl alcohol; polyethylene glycol (PEG); polyvinylpyrrolidone(s); vinyl pyrrolidone/vinyl ester copolymers; ethyl acrylate-methyl methacrylate copolymer; poly(meth)acrylic acid (co)polymers; methacrylic acid-ethyl acrylate copolymers; polyvinylacetate; vinylpyrrolidone-vinylimidazol copolymer; non-ionic surfactant based on alkoxylation; low molecular weight compounds like sugars comprising 1 to 10 sugar units or any amino acid; sugar alcohols; starch; cellulose ethers; alkyl acrylamide/acrylic acid copolymers; alkyl acrylamide/methacrylic acid copolymers; alkyl acrylamide/methyl methacrylic acid copolymers; alkyl acrylamide/acrylic acid/alkylaminoalkyl (meth)acrylic acid copolymers; alkyl acrylamide/methacrylic acid/alkylaminoalkyl (meth)acrylic acid copolymers; alkyl acrylamide/methyl methacrylic acid; alkylaminoalkyl (meth)acrylic acid copolymers; alkyl acrylamide/alkyl methacrylate/alkylaminoethyl methacrylate/alkyl methacrylate copolymers; acrylamidoalkyl trialkylammonium chloride/acrylic acid copolymers; acrylamidoalkyl trialkylamrnonium chloride/methacrylic acid copolymers; methacroyl ethyl betaine/methacrylate copolymers; vinyl acetate/crotonic acid copolymers; vinyl pyrrolidone/vinyl acrylate copolymers; acrylic acid/ethyl acrylate/N-tert-butyl acrylamide; terpolymers; graft polymers of vinyl esters; quaternized cellulose derivatives; polysiloxanes containing quaternary groups; cationic guar derivatives; polymeric dimethyl diallylammonium salts; copolymers of vinyl pyrrolidone with quaternized derivatives of dialkylaminoacrylate and methacrylate; vinyl pyrrolidone/methoimidazolinium chlorid copolymers; quaternized polyvinyl alcohol; polymers known by the INCI names of polyquaternium 2, polyquaternium 17, polyquaternium 18 and polyquaternium 27

A preferred group of water soluble materials consists in glucose, sucrose, fructose, isomalt, maltitol, polyacrylamide, polyacrylic polymer, polyvinyl pyrrolidone (PVP), polyvinyl alcohol (PVA), partially hydrolyzed polyvinyl acetate, polyisocyanates, polydiallyldimethylammonium chloride (polyDADMAC), polyethylene glycol (PEG), agar gel, alginate, gums or gelatin. Most preferably, the water-soluble material is made of poly vinyl acetate or poly vinyl alcohol.

It is possible to provide a water soluble material consisting essentially of one of the above components. In the present context, the term “consisting essentially” is meant to exclude any component or mixtures of component. Typically, this term defines that at least 98% w/w of the composition of the applicator is made of the same material, preferably at least 99% w/w and more preferably at least 99.5% w/w.

According to one embodiment, the water soluble material is a film or coating which covers at least the grip portion of the self-adhesive detergent unit composition. The external surface of the composition is preferably substantially or completely covered by the water-soluble material. The term “coating” intends to cover any layer which is mechanically and intimately linked to the substrate in contrast to the term “film”, which; albeit tightly wrapped is not mechanically linked to the substrate.

Typically, the covering material is a film which is tightly wrapped about the external surface of the detergent unit composition such as to obtain a layer of homogeneous contact which is free of evident roughness.

In the event the detergent unit composition comprises finger receiving cavities, the film follows the line of the surface of the detergent unit composition to avoid that the film covers the cavities and prevents a user to place his fingers inside the cavities. This can be done for example by using a film that retracts upon heating to adopt the shape of the detergent unit composition. The application of a uniform coating on self-adhesive detergent unit compositions which comprise cavities is also appropriate to prevent the obstruction of the cavities.

Advantageously, the sanitary agent of the present invention covered with the water-soluble film is placed in contact with the surface of the sanitary appliance to be treated, typically a slightly-moist wall for adhesion of the detergent unit composition.

The water-soluble film preferably has a thickness of from 5 to 500 μm, and more preferably from 10 to 100 μm, and still more preferably from 20 to 50 μm. The water-soluble film preferably has a density of from 0.25 to 5 g/cm3, more preferably from 1 to 3 g/cm³.

In this way, the water-soluble film enables packaging of small objects, i.e. with a length of the order of from a few millimeters to a few tens of centimeters.

According to another embodiment, the grip portion of the self-adhesive detergent unit composition is covered with a coating. Preferably, the surface of the composition is substantially or completely covered with the coating.

Appropriate coatings can amount to a thickness comprised between 5 μm and 500 μm, more preferably between 10 μm and 100 μm. This size is particularly advantageous for water soluble coatings.

According to one embodiment, the sanitary agent comprises an adhesive layer positioned on a portion of the external surface of the active body covered with the water-soluble material. This adhesive layer is able to realize a reinforced adhesion to the wall of the sanitary appliance.

As an alternative preferred embodiment, the detergent composition comprises an adhesive element dispersed therein. In this way, a reinforced adhesion to the wall of the sanitary appliance is obtained, realized by means of the adhesive component dispersed in the detergent composition.

In each of the embodiments described above, the adhesive element can be any adhesive able to guarantee good adhesion between the wall of the sanitary appliance and the products itself; useful adhesive agents can be, for example, though not limited to, poly oxy alcohol alkanes, cellulose and derivatives of cellulose, etc. The detergent unit composition can be any traditional body known in the art, solid or semi-solid, able to adhere to the wall of the sanitary element.

The self-adhesive detergent unit composition can be prepared according to the following steps: mixing the ingredient in an appropriate solvent or mixture of solvents; removing at least part of the solvent in order to harden the thus obtained form, for example by heating and molding the mixture thus obtained in an appropriate shape that exhibits a grip portion. The solvent is removed until the shaped paste becomes hard enough to be used.

The man skilled in the art would conventionally identify the minimal hardness for the contemplated invention. The grip portion of the self-adhesive detergent unit composition thus obtained is then at least partially covered with a water soluble material, e.g. with a film or a coating. A coating can be performed by any method known to the skilled person, e.g. spraying is coating techniques.

Typically, each product thus prepared may further be placed on a film individually or placed with other products onto the same film. For example, a packaging film can be made of silicone.

Before application, the user will seize the product with the fingers of one hand, i.e. with the grip portion available on one side of the product, peel the film off the adhesive surface of the product on the opposite side of the product with the other hand and apply directly the product onto the wall of the sanitary element with an appropriate pressure. Once the product is applied, the user only has to release the grip before using it.

The present invention further relates to a method for applying a product to a sanitary element, which product comprises a self-adhesive detergent unit composition that comprises a grip portion. In a specific embodiment, the detergent unit composition further has an external surface at least partially covered with material such as a film or a coating. The so material may be a water-soluble

A method within the scope of the invention comprises the steps consisting in applying the sanitary product to a moist wall of the sanitary appliance, subject the water-soluble material to a series of water flushes up to complete removal of the water soluble material, such that the active body of the detergent composition gets exposed to the action of the flush water of the sanitary appliance. Following the series of water flushing operations, the water-soluble film is completely solubilized. This way, the sanitary agent is subjected to the action of the water flushes and performs its function of deterging, disinfecting and/or perfuming the sanitary appliance while it gets solubilized in the water of the flush of the appliance itself.

Preferably, the product according to the invention can be applied to the sanitary wall in the following manner, by pressing the sanitary agent against the moist wall of the sanitary appliance and waiting for the partial removal by solubilization of the water-soluble film in the contact zones between the self-adhesive detergent unit composition and the moist wall of the sanitary element, and maintaining it pressed up until the adhesion of the composition to the wall has been realized.

1. A self-adhesive product for sanitary comprising a self-adhesive detergent unit composition shaped with a fingers grip portion, said portion being optionally covered on its external surface.

2. A self-adhesive product according to claim 1, wherein the finger grip portion is covered with a water-soluble material.

3. The product according to claim 1, where the water soluble material is a film or a coating.

4. The product according to claim 3, wherein the film or coating has a thickness of 5 to 500 μm, more preferably from 10 to 100 μm and even more preferably from 20 to 50 μm.

5. The product according to claim 2, wherein the selected water soluble material is selected among soluble polymers, biodegradable plastics, saccharide based components, polyamide resin mixtures or soluble gelling agents or mixtures thereof.

6. The product according to claims 5, wherein
the soluble polymer is selected among isomalt, maltitol, polyacrylamide, polyacrylic polymer, polyvinyl pyrrolidone (PVP), polyisocyanates, polydiallyldimethylammonium chloride (polyDADMAC), polyethylene glycol (PEG); polyvinyl alcohol (PVA), partially hydrolyzed polyvinyl acetate or mixtures thereof;
the saccharide based component is a monosaccharide, a dissacharide, glucose, sucrose, fructose or mixtures thereof;
the gelling agent is selected among agar gel, alginate, gums or gelatin or mixtures thereof.

7. The product according to claim 1, wherein the fingers grip portion of the self-adhesive detergent unit composition is materialized by at least one protruding portion.

8. The product according to claim 7, wherein the protruding portion has a thickness within the range of about 0.6 to about 16 mm, preferably about 2 to about 10 mm, and most preferably of about 8 mm.

9. The product according to claim 1, wherein the fingers grip portion, of the detergent unit composition is materialized by one or several finger receiving cavities within the volume of the composition said cavities being located on one the same side of the detergent composition.

10. The product according to claim 9, wherein the detergent unit composition comprises two or three finger receiving cavities.

11. The product according to claim 9, wherein the depth of the finger receiving cavities are within the range of about 0.6 to about 16 mm, preferably about 2 to about 10 mm, and most preferably of about 8 mm.

12. The product according to claim 1, which further comprises an adhesive layer positioned on at least a portion of the external surface of the active body covered with the water-soluble film.

13. The product according to claim 1, which further comprises an additional adhesive element which is dispersed in a material of the active body.

14. The product according to claim 1, wherein the self-adhesive composition comprises an additive such as disinfectants, insecticides, enzymes, colored particles, preservatives, biocides, anti-lime scale, dyes, colorant and/or antibacterial agents therein in an amount of from 0 to 20 wt % of the total weight of the applicator, preferably from 1 to 5 wt %.

15. The product according to claim 1, wherein the self-adhesive composition comprises perfume, in an amount of from 1 to 25 wt % of the total weight applicator, preferably from 1 to 20 wt %.

16. A process for the manufacture of a soluble applicator according to claim 1, comprising (a) the mixing of the-mixing the ingredients into a solvent or mixture of solvents, (b) removing at least part of the solvent to harden the form thus obtained (c) shaping the paste thus obtained into the desired shape (d) covering the grip portion.

17. Use of a product according to claim 1, into a sanitary element, preferably a toilet basin.

18. Use according to claim 17, wherein the product is applied by a user holding the grip to a dry, moist or wet wall and pressed until the product has adhered.

19. Use of the self-adhesive product according to claim 1 for cleaning, disinfecting and/or deodorizing a sanitary element, preferably a toilet basin.
